(19) United States
(12) Patent Application Publication
(10) Pub. No.: US 2008/0063234 A1
(43) Pub. Date: Mar. 13, 2008

(54) ELECTROACOUSTIC TRANSDUCER

(75) Inventor: Keita Watanabe, Fujiyoshida-shi (JP)

Correspondence Address: BRINKS HOFER GILSON & LIONE, P.O. BOX 10395, CHICAGO, IL, 60610, US

(73) Assignee: Citizen Electronics Co., Ltd., Fujiyoshida-shi (JP)

(21) Appl. No.: 11/849,810

(22) Filed: Sep. 4, 2007

(30) Foreign Application Priority Data
Sep. 7, 2006 (JP) JP2006-243229

(51) Int. Cl. H04R 9/06

(52) U.S. Cl. 381/405

(57) ABSTRACT

An electroacoustic transducer includes a yoke (1) having an annular intermediate yoke portion (1a), an inner yoke portion (1b) and an outer yoke portion (1c), a permanent magnet (3) provided on the outer yoke portion so as to surround the inner yoke portion and forming a magnetic gap (G) between itself and the inner yoke portion (1b), a voice coil (6) inserted into the magnetic gap, and a diaphragm (4) supporting the voice coil. The diaphragm has an outer annular portion (4a) secured to the inner peripheral surface of the outer yoke portion (1c) and extending toward the inner yoke portion, an inner portion (4b) disposed to face the distal end opening (1e) of the inner yoke portion (1b), and a cylindrical portion (4c) connected between the inner portion and the outer annular portion. The inner portion (4b) of the diaphragm has a dome portion that is convex toward the distal end opening.

This application claims priority under 35 U.S.C. §119 to Japanese Patent application No. JP2006-243229 filed on Sep. 7, 2006, the entire contents of which are hereby incorporated by reference.

### TECHNICAL FIELD

The present invention relates to a structure of an electrodynamic electroacoustic transducer suitable for use in relatively compact electronic devices having the function of a speaker, a receiver (earphone), a microphone, etc.

### RELATED ART

Recently, mobile phones and other compact information devices that handle images and sound have been developed to be more multifunctional and required to provide an increased area for image information. These compact information devices have also been required to have additional functions such as a camera function. Under these circumstances, it has been demanded that electroacoustic transducers used in these information devices to generate sound should be installed in a narrower space despite strong demand for them to provide high sound quality and high sound volume.

FIG. 14 shows a typical structure of a speaker as an example of such electroacoustic transducers that is disclosed, for example, in Japanese Patent Application Publication No. 2001-309487. A cup-shaped yoke 1 made from a soft magnetic material is molded in a plastic (non-magnetic) frame 11. The yoke 1 is provided in the center thereof with a disk-shaped vertically magnetized permanent magnet 3 and a disk-shaped top plate 9 of a soft magnetic material secured to the top of the permanent magnet 3 to form a magnetic circuit through a magnetic gap G between a peripheral edge of the top plate 9 and an upper end edge of the yoke 1.

A diaphragm 4 is a substantially disk-shaped thin plastic plate. The diaphragm 4 has a ring-shaped outer peripheral portion 4a fixedly bonded through a spacer 5 to a step portion formed on the inner wall surface of the frame 11. The diaphragm 4 has a ring-shaped outer peripheral dome 4b, a thin ring-shaped flat portion 4c and a center dome 4e formed in the order mentioned radially inward from the ring-shaped outer peripheral portion 4a. The outer peripheral dome 4b and the center dome 4e are curved to impart thereto moderate elasticity and rigidity necessary for the diaphragm 4 to vibrate acoustically. Further, a multiplicity of fine grooves (radial, annular, spiral or other shallow projections or recesses) may be formed on the outer peripheral dome 4b and the center dome 4e, if necessary, to adjust elasticity and rigidity.

A cylindrical voice coil 6 is fixedly bonded to the flat portion 4c and inserted into the magnetic gap G. Terminal wires of the voice coil 6 are, usually, led to the outside along the diaphragm surface, although not shown in the figure. When supplied with a speech current, the voice coil 6 moves vertically in the magnetic gap G, causing the diaphragm 4 to vibrate to generate sound. A thin cup-shaped protector 10 made from a metal sheet or the like is provided so as to cover the upper side of the diaphragm 4. The protector 10 is provided with sound release holes 7. It should be noted that the line representing the upper edge of the yoke 1 and the line representing the lower edge of the voice coil 6, which should be shown at the back of the sectional view of FIG. 14, are not illustrated in the figure for the sake of clarity of the illustration.

FIG. 15 shows a speaker having another structure that is disclosed, for example, in Japanese Patent Application Publication No. 2001-169390. The basic configurational structure is the same as that shown in FIG. 14. In the speaker shown in FIG. 15, the diaphragm 4 has a U-shaped bent portion 4f, and the voice coil 6 is wound directly around an outer surface of the U-shaped bent portion 4f. The JP publication states that this speaker structure dispenses with the voice coil bonding process and that the positioning accuracy of the voice coil is improved and hence the characteristics and quality are stabilized.

FIG. 16 shows a speaker having still another structure that is disclosed in Japanese Patent Application Publication No. Sho 55-135500. This speaker has a yoke 1 with a center pole 1′, an annular frame 11 provided on an outer peripheral edge of the yoke 1, and an annular permanent magnet 2 secured to an inner peripheral surface of the annular frame 11. The permanent magnet 2 has been magnetized in the radial direction. A magnetic gap G is formed between the inner peripheral surface of the permanent magnet 2 and the center pole 1′ of the yoke 1. A voice coil 6 set in the magnetic gap G is attached to the periphery of a cylindrical portion 4g of a diaphragm 4 raised so as to surround the center pole 1′.

In the electroacoustic transducer shown in FIG. 14, positioning accuracy when the voice coil is bonded to the flat portion of the diaphragm is a problem. If the positioning accuracy is low, the magnetic gap needs to be widened. If the magnetic gap is widened, the magnetic reluctance increases, so that it becomes impossible to increase the magnetic flux density in the magnetic gap. The electroacoustic transducer shown in FIG. 15 can solve the problem of the voice coil positioning accuracy but has a limitation in narrowing the magnetic gap because of the presence of the U-shaped bent portion 4f of the diaphragm 4. In the electroacoustic transducer shown in FIG. 16, the voice coil positioning accuracy can be increased, and the magnetic gap can be narrowed. However, the cross-sectional area of the center pole is small, and the diameter of the voice coil 6 is small. Therefore, the area of the end surface portion of the cylindrical portion 4g, where the center of vibration of the diaphragm 4 is located, is small, and the amount of vibration of the diaphragm 4 caused by the vibration of the voice coil 6 is small. Consequently, the sound pressure (sound volume) is unfavorably low.

### SUMMARY OF THE INVENTION

An object of the present invention is to improve conventional electroacoustic transducers as described above.

The present invention provides an electroacoustic transducer including a yoke, at least one permanent magnet, a cylindrical voice coil, and a diaphragm. The yoke has an annular intermediate yoke portion, a cylindrical inner yoke portion extending from a radially inner peripheral edge of the intermediate yoke portion in an axial direction of the intermediate yoke portion, and a cylindrical outer yoke portion extending in the axial direction from a radially outer peripheral edge of the intermediate yoke portion and having an inner peripheral surface that forms a cylindrical space between itself and the outer peripheral surface of the inner yoke portion. The at least one permanent magnet is provided to surround the inner yoke portion at a position away from the intermediate yoke portion in the axial direction. The at least one permanent magnet has been magnetized in the radial direction of the yoke and forms a magnetic gap between itself and the outer peripheral surface of the inner yoke portion. The cylindrical voice coil is inserted into the cylindrical space in the axial direction to extend into the magnetic gap in the axial direction. The diaphragm supports the voice coil and has an outer annular portion secured to either the inner peripheral surface of the outer yoke portion or a neighborhood of the inner peripheral surface to extend toward the inner yoke portion, an inner portion disposed to face the distal end opening of the inner yoke portion, and a cylindrical portion connected between a radially outer peripheral edge of the inner portion and a radially inner peripheral edge of the outer annular portion.

In this electroacoustic transducer, the inner portion of the diaphragm is disposed to face the distal end opening of the inner yoke portion. Therefore, even if the diaphragm vibrates with a large amplitude at the inner portion thereof, the diaphragm is unlikely to contact the inner yoke portion of the yoke. Accordingly, the diaphragm is allowed to vibrate with a large amplitude to obtain a high sound pressure.

Specifically, the electroacoustic transducer may be arranged as follows. The outer yoke portion of the yoke is longer in length in the axial direction than the inner yoke portion. The permanent magnet is secured to a portion of the outer yoke portion that extends beyond the inner yoke portion in the axial direction. The outer annular portion of the diaphragm is positioned in between the inner yoke portion and the outer yoke portion. The cylindrical portion of the diaphragm extends in the axial direction from the radially inner peripheral edge of the outer annular portion of the diaphragm and is connected to the radially outer peripheral edge of the inner portion of the diaphragm at a position beyond the distal end opening of the inner yoke portion in the axial direction.

Because the outer annular portion of the diaphragm is set at the above-described position, the permanent magnet can be set closer to the intermediate yoke portion. Thus, the electroacoustic transducer can be formed thin in thickness.

More specifically, the voice coil may be secured onto the inner portion of the diaphragm at a position adjacent to the inner peripheral surface of the cylindrical portion of the diaphragm.

If the voice coil is secured to the outer portion of the diaphragm, when the diaphragm is vibrated, deflection due to vibration occurs at two locations, i.e. the vicinity of the joint between the outer portion and the cylindrical portion of the diaphragm, and the vicinity of the joint between the cylindrical portion and the inner portion of the diaphragm. In contrast, if the voice coil is set as stated above, deflection of the diaphragm due to vibration occurs mainly at one location, i.e. the vicinity of the position on the inner portion of the diaphragm where the voice coil is secured. Consequently, noise generation is suppressed when the diaphragm vibrates.

The electroacoustic transducer may be arranged as follows. The voice coil has a planar shape as viewed in the axial direction thereof. The planar shape has a pair of mutually spaced and opposed long-side portions and a pair of short-side portions connecting between the mutually opposing ends of the long-side portions. The at least one permanent magnet includes a pair of bar-shaped permanent magnets disposed outside the long-side portions, respectively, of the voice coil to face the long-side portions, and a ring-shaped magnet support formed from a soft magnetic material and configured to surround the voice coil. The magnet support has an inner surface and an outer surface. The bar-shaped permanent magnets are secured to the inner surface of the magnet support, and the outer surface of the magnet support is secured to the inner peripheral surface of the outer yoke portion.

The planar shape of the voice coil shall include not only a rectangular shape but also an oval or elliptical shape. The magnet support may be formed from a soft magnetic material or a plastic material. The magnet support may have a ring shape. Alternatively, the magnet support may include a pair of bar-shaped magnet support segments facing the long-side portions, respectively, of the voice coil.

The at least one permanent magnet may further include additional bar-shaped permanent magnets disposed outside the short-side portions, respectively, of the voice coil to face the short-side portions. In this case, the additional bar-shaped permanent magnets are secured to the inner surface of the magnet support.

Conversely to the above, the permanent magnets may be secured to the outer peripheral surface of the magnet support. In this case, the permanent magnets may be secured to the inner peripheral surface of the outer yoke portion. It should be noted that, with a view to surely and stably securing the permanent magnets to the magnet support, the surface of the magnet support to which the permanent magnets are to be secured may be formed into an L-shape, for example, to increase the area of contact therebetween.

The inner portion of the diaphragm may have a dome portion that is convex toward the distal end opening of the inner yoke portion. Providing such a dome portion makes it possible to increase the rigidity of the inner portion of the diaphragm and enables the inner portion to have an increased area. Moreover, because the inner yoke portion is cylindrical and has an opening at the distal end thereof, when the inner portion of the diaphragm vibrates, the dome portion is unlikely to contact the inner yoke portion. Accordingly, the diaphragm is allowed to vibrate with a large amplitude to obtain a high sound pressure.

The voice coil may be secured onto the diaphragm at a position adjacent to the outer peripheral surface of the cylindrical portion of the diaphragm.

Further, the electroacoustic transducer may be arranged as follows. The voice coil has a planar shape as viewed in the axial direction thereof. The planar shape has a pair of mutually spaced and opposed long-side portions and a pair of short-side portions connecting between the mutually opposing ends of the long-side portions. The at least one permanent magnet includes a pair of U-shaped permanent magnets provided outside the voice coil. The pair of U-shaped permanent magnets respectively have intermediate portions positioned to face the short-side portions of the voice coil and pairs of extensions extending from the intermediate portions, respectively, so as to face the long-side portions at both sides of the short-side portions. The pair of U-shaped permanent magnets are disposed so that their distal ends face each other.

### BRIEF DESCRIPTION OF THE DRAWINGS

FIG. 1 is a plan view of a speaker as a first embodiment of the electroacoustic transducer according to the present invention.

FIG. 2 is a sectional view taken along the line II-II in FIG. 1.

FIG. 3 is a sectional view taken along the line III-III in FIG. 1.

FIG. 4 is an enlarged sectional view of a diaphragm and its associated members constituting the speaker shown in FIG. 1.

FIG. 5 is a sectional view showing a modification of a yoke of the speaker in FIG. 1.

FIG. 6 is a sectional view similar to FIG. 2, showing a speaker according to a second embodiment of the present invention.

FIG. 7 is a bottom view showing members constituting a magnetic circuit of a speaker according to a third embodiment of the present invention, in which illustration of a bottom plate and a diaphragm of the speaker is omitted to clarify the essential part thereof.

FIG. 8 is a bottom view similar to FIG. 7, showing members constituting a magnetic circuit of a speaker according to a fourth embodiment of the present invention.

FIG. 9 is a bottom view similar to FIG. 7, showing members constituting a magnetic circuit of a speaker according to a fifth embodiment of the present invention.

FIG. 10 is a bottom view similar to FIG. 7, showing members constituting a magnetic circuit of a speaker according to a sixth embodiment of the present invention.

FIG. 11 is a graph showing acoustic characteristics of a speaker according to the present invention.

FIG. 12 is a sectional view similar to FIG. 2, showing a speaker according to a seventh embodiment of the present invention.

FIG. 13 is a sectional view similar to FIG. 2, showing a speaker according to an eighth embodiment of the present invention.

FIG. 14 is a sectional view of a conventional speaker.

FIG. 15 is a sectional view of another type of conventional speaker.

FIG. 16 is a sectional view of still another type of conventional speaker.

FIG. 17 is a sectional view showing a modification of a magnet support.

### DETAILED DESCRIPTION OF THE INVENTION

Embodiments of an electroacoustic transducer according to the present invention will be described below with reference to the accompanying drawings.

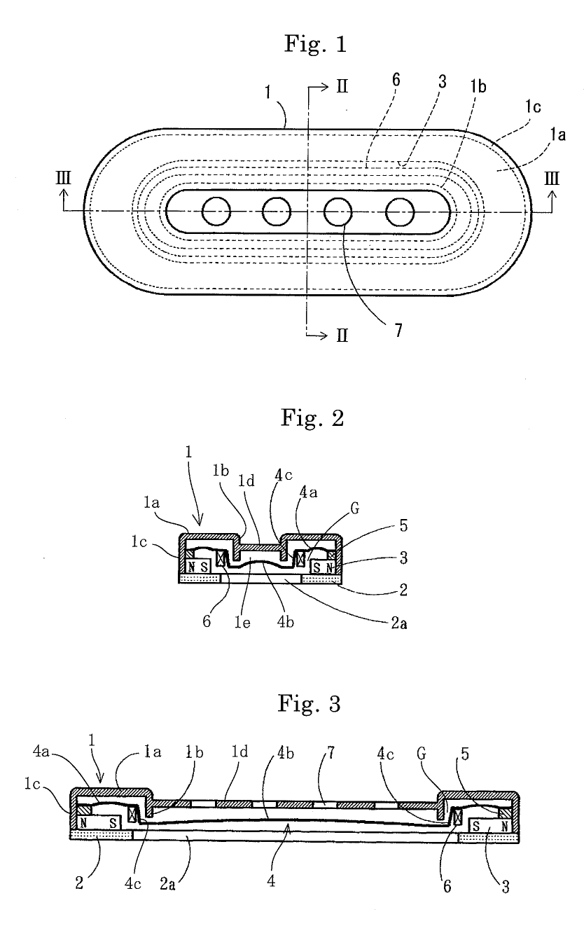

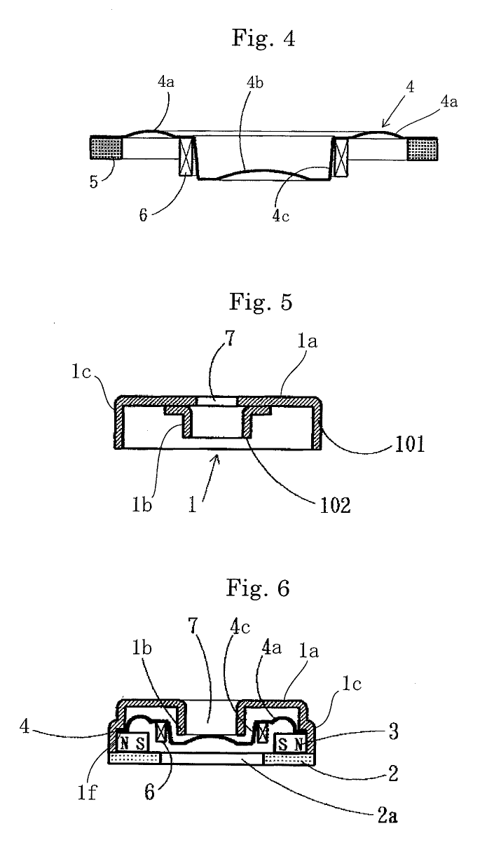

FIGS. 1 to 4 show a speaker as an electroacoustic transducer according to the present invention. The speaker has a flattened oval configuration as a whole so as to be suitable for use in compact information devices such as mobile phones.

The speaker has a yoke 1 formed by drawing a plate of a soft magnetic material, e.g. permalloy or soft iron, a bottom plate 2 of a non-magnetic material, a permanent magnet 3, a diaphragm 4, and a voice coil 6.

The yoke 1 and the bottom plate 2 form in combination a casing of the speaker. The speaker is mounted on a motherboard (not shown) of a compact information device, e.g. a cellular phone, with the bottom plate 2 placed in contact with the motherboard. In this regard, the bottom plate 2 may be formed from a part of the motherboard. In the illustrated example, the bottom plate 2 is provided with an opening 2a for releasing a back pressure to reduce resistance to the vibration when the diaphragm 4 vibrates.

The yoke 1 has, as shown in FIG. 1, an oval shape as a whole as viewed in the axial direction of the yoke 1. As shown in FIGS. 2 and 3, the yoke 1 has an annular intermediate yoke portion 1a, a cylindrical inner yoke portion 1b extending from a radially inner peripheral edge of the intermediate yoke portion 1a in the axial direction of the intermediate yoke portion 1a (downward as viewed in FIG. 2), and a cylindrical outer yoke portion 1c extending axially from a radially outer peripheral edge of the intermediate yoke portion 1a and having an inner peripheral surface that forms a cylindrical space between itself and an outer peripheral surface of the inner yoke portion 1b. The inner yoke portion 1b has a reinforcing plate 1d provided on an axially central portion thereof. The reinforcing plate 1d is oval as viewed in FIG. 1 and has a plurality of sound release holes 7 provided in series along a longitudinal direction thereof.

The permanent magnet 3 has an oval ring shape and is secured to the inner peripheral surface of a portion of the outer yoke portion 1c that is extended axially beyond the inner yoke portion 1b. The permanent magnet 3 has been magnetized in a radial direction of the yoke 1 (in a horizontal direction as viewed in FIGS. 2 and 3). The permanent magnet 3 forms a magnetic gap G between an inner peripheral surface thereof and the outer peripheral surface of the inner yoke portion 1b.

The diaphragm 4 has an end portion secured onto the permanent magnet 3 through a spacer 5 at a position adjacent to the inner peripheral surface of the outer yoke portion 1c. The diaphragm 4 further has an outer annular portion 4a extending from the end portion toward the inner yoke portion 1b, an inner portion 4b disposed to face an opening 1e at a distal end (lower end as viewed in FIG. 1) of the inner yoke portion 1b, and a cylindrical portion 4c connected between a radially outer peripheral edge of the inner portion 4b and a radially inner peripheral edge of the outer annular portion 4a. To enhance the rigidity of the diaphragm 4, the section of the outer annular portion 4a is upward convex as viewed in FIG. 1, and the inner portion 4b has a dome portion that is convex toward the distal end opening 1 of the inner yoke portion 1b.

The voice coil 6 is secured to a lower side of the outer annular portion 4a of the diaphragm 4 at a position adjacent to the outer peripheral surface of the cylindrical portion 4c thereof so as to extend into the magnetic gap G in the axial direction.

FIG. 5 shows a modification of the yoke of the above-described speaker.

Permalloy, which is a desirable material for the yoke 1, is a difficult-to-work material, and hence it is not always easy to integrally form a complicated shape from permalloy by plastic working. Therefore, in this modification, a cup-shaped member 101 having an intermediate yoke portion 1a and a cylindrical outer yoke portion 1c and a cylindrical member 102 having an inner yoke portion 1b are formed from respective plate materials, and the cup-shaped member 101 and the cylindrical member 102 are joined together by spot welding or the like to form the yoke 1. The cup-shaped member 101 is provided with sound release holes 7.

FIG. 6 shows a speaker according to another embodiment of the present invention. This speaker differs from the speaker shown in FIGS. 1 to 4 in that the outer peripheral edge of the diaphragm 4 is secured by being clamped between the permanent magnet 3 and a step portion 1f provided on the inner peripheral surface of the outer yoke portion 1c. In addition, an adhesive may be used, if necessary, to secure the outer peripheral edge of the diaphragm 4. This structure enables omission of the spacer 5 to reduce the number of component parts and also makes it possible to increase the positioning accuracy of the diaphragm 4. Further, the inner yoke portion 1b is provided with no reinforcing plate 1d as shown in FIG. 2, and the opening of the inner yoke portion 1b is used as a sound release hole 7, thereby dispensing with machining process to form sound release holes 7. Because the opening of the inner yoke portion 1b serving as a sound release hole 7 has a wide area, acoustic resistance is advantageously low.

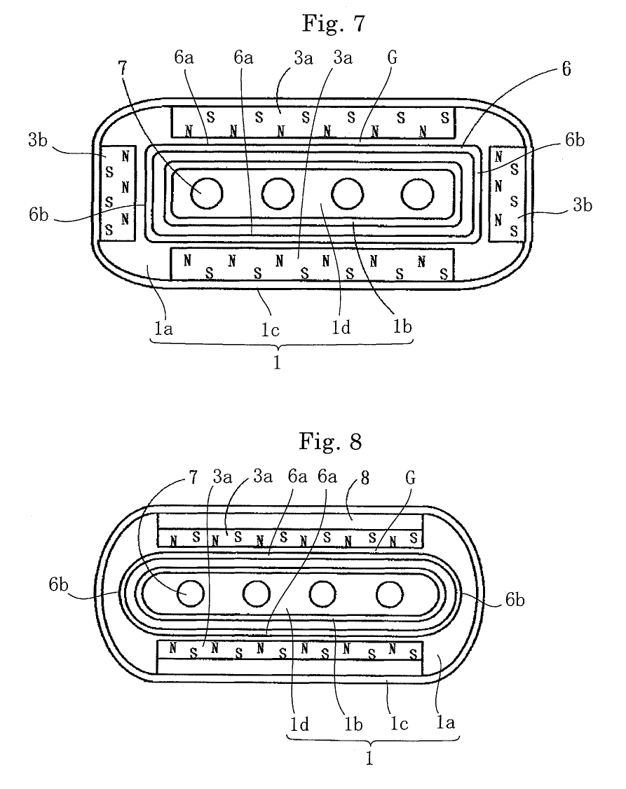

FIG. 7 is a bottom view of a speaker according to still another embodiment of the present invention. To clarify the feature of this embodiment, illustration of the bottom plate 2 and the diaphragm 1 is omitted in FIG. 7. In this speaker, the voice coil 6 has an elongated shape as a whole that is defined by a pair of mutually spaced and opposed long-side portions 6a and a pair of short-side portions 6b connecting between the mutually opposing ends of the long-side portions 6a. Further, in this speaker, the permanent magnet 3 comprises a pair of bar-shaped permanent magnets 3a disposed outside the long-side portions 6a, respectively, of the voice coil 6 to face the associated long-side portions 6a, and a pair of bar-shaped permanent magnets 3b disposed outside the short-side portions 6b, respectively, of the voice coil 6 to face the associated short-side portions 6b. The use of bar-shaped magnets as the permanent magnet can reduce the manufacturing cost of the speaker in comparison to the speaker using a single ring-shaped permanent magnet as shown in FIGS. 1 to 4 and yet enables realization of a speaker having characteristics substantially equivalent to those of the speaker shown in FIGS. 1 to 4. It is also possible to quickly cope with a design change request for changing the size or shape of the speaker.

FIG. 8 is a bottom view similar to FIG. 7, showing a speaker according to a further embodiment of the present invention. In this speaker, the narrow bar-shaped permanent magnets 3a is disposed to face the long-side portions 6a, respectively, of the voice coil 6. The permanent magnets 3a are secured to the inner peripheral surface of the outer yoke portion 1c through respective magnet supports 8 comprising bar-shaped soft magnetic members.

The positional relationship between each bar-shaped permanent magnet 3 and the associated magnet support 8 may be reversed. With this arrangement also, a speaker having characteristics similar to those of the above-described speaker can be obtained. In this embodiment, there are no magnetic members or the like outside the short-side portions 6b of the voice coil 6. Therefore, the longitudinal size of the speaker can be reduced. Alternatively, it is possible to increase the length of the long-side portions 6a of the voice coil 6 relative to the length of the speaker.

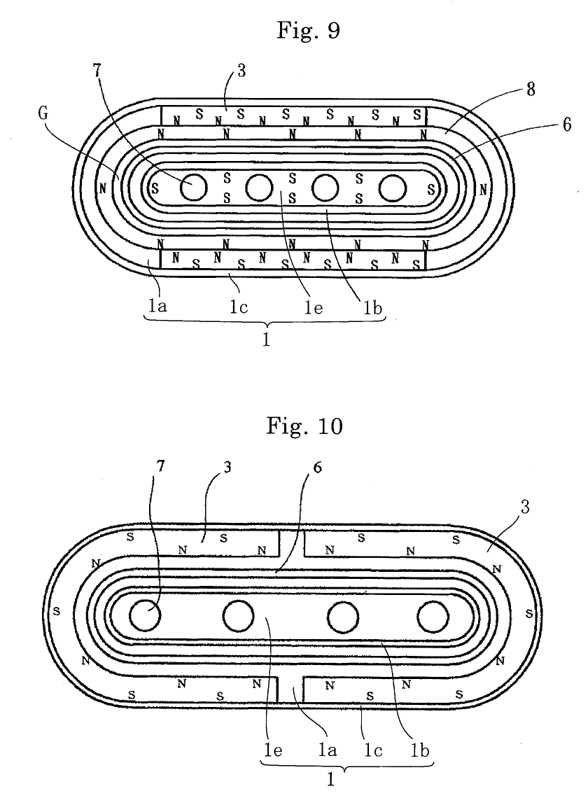

FIG. 9 is a bottom view similar to FIG. 7, showing a speaker according to a still further embodiment of the present invention.

In this speaker, two bar-shaped permanent magnets 3 are disposed along the inner peripheral surface of the outer yoke portion 1c, and a ring-shaped magnet support 8 formed from a soft magnetic material is secured to the inner side surfaces of the permanent magnets 3. With this arrangement, although two separate permanent magnets 3 are provided, an annular magnetic gap G can be formed between the inner yoke portion 1b and the magnet support 8. Accordingly, the voice coil 6 can be driven efficiently.

FIG. 10 is a bottom view similar to FIG. 7, showing a speaker according to a still further embodiment of the present invention. In this speaker, C-shaped permanent magnets 3 are secured to the inner peripheral surface of the inner yoke portion 1b. With this arrangement, it is possible to obtain speaker characteristics equivalent to those of the speaker using an oval permanent magnet 3 that is shown in FIGS. 1 to 4.

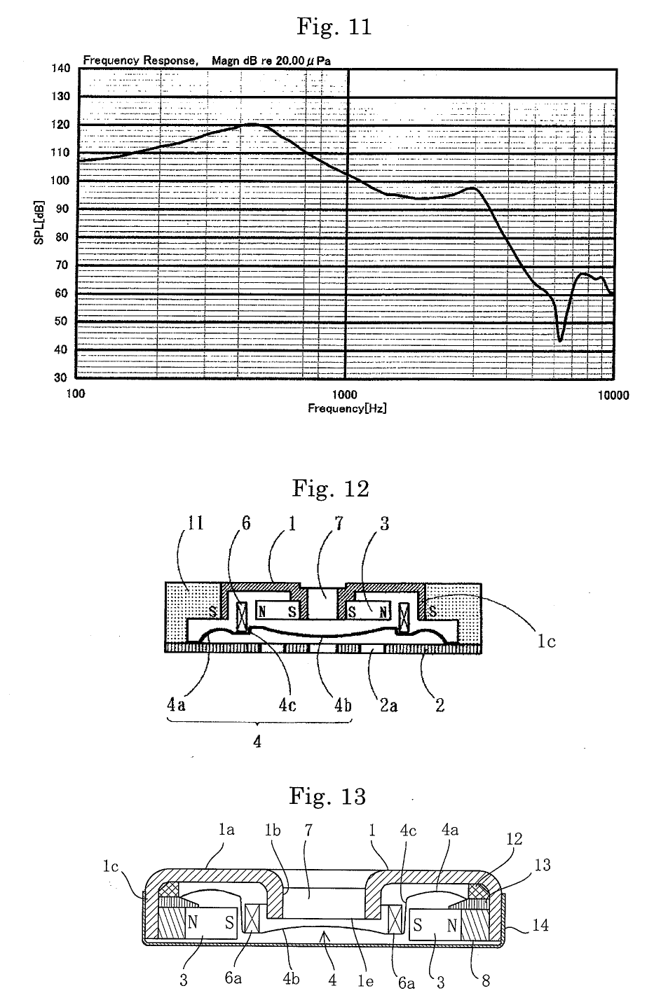

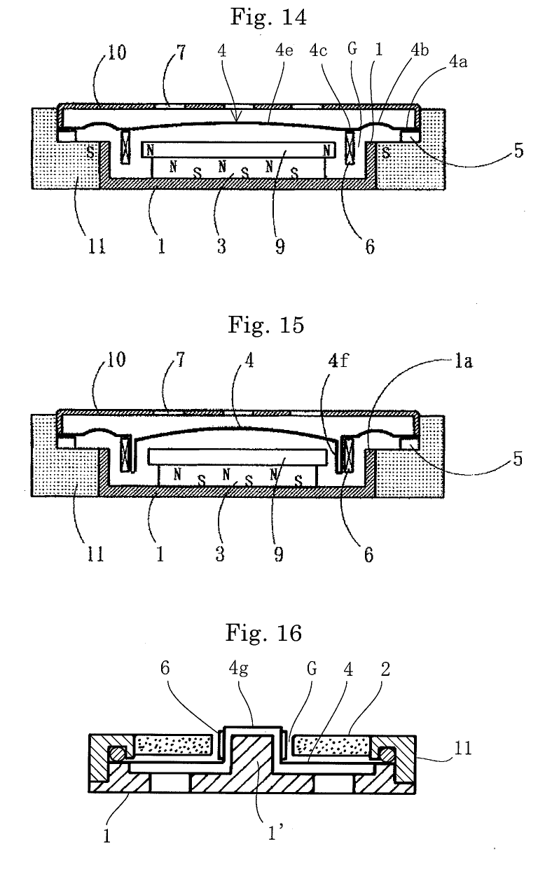

FIG. 11 is a graph showing results of measurement of acoustic characteristics of a speaker having a structure similar to that of the speaker shown in FIG. 8. A sine wave of 0.179 Vrms (100 Hz to 10 kHz) was input to the speaker, and the sound pressure output therefrom was recorded. As seen in the graph, the frequency fh (resonance point at which the sound pressure drops in the high frequency region) is somewhat low, but at frequencies below it, the speaker can attain sound pressure levels equivalent to those of conventional speakers despite its thin profile.

FIG. 12 shows a speaker according to a still further embodiment of the present invention. This embodiment differs from the foregoing embodiments in that the ring-shaped permanent magnet 3 is secured to an outer peripheral surface of the inner yoke portion 1b, that the cylindrical portion 4c of the diaphragm 4 is reduced in height (the height of the cylindrical portion 4c only needs to be more than about several percent of the height of the voice coil 6) to use it only for positioning the voice coil 6 and disposed outside the magnetic gap, and that both the yoke 1 and the permanent magnet 3 are disposed at one side (upper side in FIG. 12) of the diaphragm 4.

In this embodiment also, the positioning of the voice coil can be facilitated, and it is possible to achieve a thin and compact speaker and to minimize the number of components parts.

FIG. 13 is a sectional view similar to FIG. 2, showing a speaker according to a still further embodiment of the present invention.

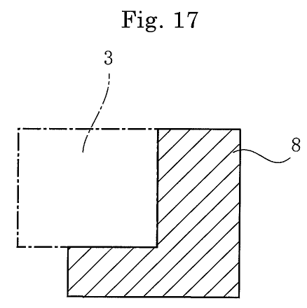

In this speaker, the yoke 1 has the same overall structure as that of the speaker shown in FIG. 6, but the voice coil 6 is disposed at a position adjacent to the inner peripheral surface of the cylindrical portion 4c of the diaphragm 4 and secured to the inner portion 4b of the diaphragm 4. Further, the permanent magnet 3 comprises, although not shown in FIG. 13, a pair of bar-shaped permanent magnets disposed outside the long-side portions 6a, respectively, of the voice coil 6 to face the associated long-side portions 6a. The pair of permanent magnets are secured to the inner peripheral surface of a ring-shaped magnet support 8 (such as that shown in FIG. 9) disposed around the outer peripheries of the permanent magnets. In assembling of the speaker, the pair of permanent magnets that have been secured to the magnet support 8 in advance are incorporated as one unit, thereby facilitating the assembling operation. The magnet support 8 may be formed into an L shape in section as shown in FIG. 17 to increase the area of contact with the permanent magnets, thereby allowing the permanent magnets to be stably secured to the magnet support 8. Although in the foregoing embodiments soft magnetic members are used as the magnet supports, plastic members are also usable. In FIG. 13, reference numerals 12 and 13 denote ring-shaped members for securing the outer peripheral edge of the diaphragm 4. The ring-shaped members, 12 and 13 also serve to prevent the permanent magnets from being dislodged toward the yoke 1 when the electroacoustic transducer receives an impact due to a drop or the like. The ring-shaped member 13 may be provided with an inclined surface so as not to interfere with the vibration of the diaphragm 4. Reference numeral 14 denotes a protector attached to the outer peripheral surface of the outer yoke portion.

1. An electroacoustic transducer comprising:
a yoke having an annular intermediate yoke portion, a cylindrical inner yoke portion extending from a radially inner peripheral edge of said intermediate yoke portion in an axial direction of said intermediate yoke portion, and a cylindrical outer yoke portion extending in said axial direction from a radially outer peripheral edge of said intermediate yoke portion and having an inner peripheral surface that forms a cylindrical space between itself and an outer peripheral surface of said inner yoke portion;
at least one permanent magnet provided to surround said inner yoke portion at a position away from said intermediate yoke portion in said axial direction, said at least one permanent magnet having been magnetized in a radial direction of said yoke and forming a magnetic gap between itself and the outer peripheral surface of said inner yoke portion;
a cylindrical voice coil inserted into said cylindrical-space in said axial direction to extend into said magnetic gap in said axial direction; and
a diaphragm that supports said voice coil, said diaphragm having an outer annular portion secured to either the inner peripheral surface of said outer yoke portion or a neighborhood of said inner peripheral surface to extend toward said inner yoke portion, an inner portion disposed to face a distal end opening of said inner yoke portion, and a cylindrical portion connected between a radially outer peripheral edge of said inner portion and a radially inner peripheral edge of said outer annular portion.

2. The electroacoustic transducer of claim 1, wherein said outer yoke portion of said yoke is longer in length in said axial direction than said inner yoke portion;
said permanent magnet being secured to a portion of said outer yoke portion that extends beyond said inner yoke portion in said axial direction;
said outer annular portion of said diaphragm being positioned in between said inner yoke portion and said outer yoke portion; and
said cylindrical portion of said diaphragm extending in said axial direction from the radially inner peripheral edge of said outer annular portion of said diaphragm, said cylindrical portion being connected to the radially outer peripheral edge of said inner portion of said diaphragm at a position beyond said distal end opening of said inner yoke portion in said axial direction.

3. The electroacoustic transducer of claim 2, wherein said voice coil is secured onto said inner portion of said diaphragm at a position adjacent to an inner peripheral surface of said cylindrical portion of said diaphragm.

4. The electroacoustic transducer of claim 1, wherein said voice coil has a planar shape as viewed in an axial direction thereof, said planar shape having a pair of mutually spaced and opposed long-side portions and a pair of short-side portions connecting between mutually opposing ends of said long-side portions;
said at least one permanent magnet including a pair of bar-shaped permanent magnets disposed outside said long-side portions, respectively, of said voice coil to face said long-side portions, said at least one permanent magnet further including a magnet support disposed to surround said voice coil, said magnet support having an inner surface and an outer surface;
wherein said bar-shaped permanent magnets are secured to said inner surface of said magnet support, and said outer surface of said magnet support is secured to the inner peripheral surface of said outer yoke portion.

5. The electroacoustic transducer of claim 4, wherein said at least one permanent magnet further includes additional bar-shaped permanent magnets disposed outside said short-side portions, respectively, of said voice coil to face said short-side portions, said additional bar-shaped permanent magnets being secured to the inner surface of said magnet support.

6. The electroacoustic transducer of claim 1, wherein said inner portion of said diaphragm has a dome portion that is convex toward said distal end opening of said inner yoke portion.

7. The electroacoustic transducer of claim 1, wherein said voice coil is secured onto said diaphragm at a position adjacent to an outer peripheral surface of said cylindrical portion of said diaphragm.

8. The electroacoustic transducer of claim 1, wherein said voice coil has a planar shape as viewed in an axial direction thereof, said planar shape having a pair of mutually spaced and opposed long-side portions and a pair of short-side portions connecting between mutually opposing ends of said long-side portions;
said at least one permanent magnet including an annular magnet support disposed to surround said voice coil, said magnet support having an inner surface and an outer surface, said at least one permanent magnet further including a pair of permanent magnets secured between the outer peripheral surface of said magnet support and the inner peripheral surface of said outer yoke portion at respective positions corresponding to said long-side portions, respectively, of said voice coil.

9. The electroacoustic transducer of claim 1, wherein said voice coil has a planar shape as viewed in an axial direction thereof, said planar shape having a pair of mutually spaced and opposed long-side portions and a pair of short-side portions connecting between mutually opposing ends of said long-side portions;
said at least one permanent magnet including a pair of U-shaped permanent magnets provided outside said voice coil, said pair of U-shaped permanent magnets respectively having intermediate portions positioned to face said short-side portions of said voice coil and pairs of extensions extending from said intermediate portions, respectively, so as to face said long-side portions at both sides of said short-side portions, said pair of U-shaped permanent magnets being disposed so that distal ends of said pairs of extensions of said pair of U-shaped permanent magnets face each other.

10. The electroacoustic transducer of claim 4, wherein said magnet support has an L-shape in section, said bar-shaped permanent magnets being supported by said magnet support in engagement with said L-shape.

11. The electroacoustic transducer of claim 8, wherein said magnet support has an L-shape in section, said bar-shaped permanent magnets being supported by said magnet support in engagement with said L-shape.

12. The electroacoustic transducer of claim 1, further comprising a bottom plate secured to an end of said outer yoke portion remote from said intermediate yoke portion, said bottom plate having an opening.

13. The electroacoustic transducer of claim 4, wherein said magnet support is formed from a soft magnetic material.

14. The electroacoustic transducer of claim 4, wherein said magnet support is formed from a plastic material.

15. The electroacoustic transducer of claim 4, wherein said magnet support has a ring shape.

16. The electroacoustic transducer of claim 4, wherein said magnet support includes a pair of bar-shaped magnet support segments disposed outside said long-side portions, respectively, of said voice coil to face said long-side portions, said pair of bar-shaped magnet support segments having said bar-shaped permanent magnets secured thereto, respectively.

17. An electroacoustic transducer comprising:
a yoke having an annular intermediate yoke portion, a cylindrical inner yoke portion extending from a radially inner peripheral edge of said intermediate yoke portion in an axial direction of said intermediate yoke portion, and a cylindrical outer yoke portion extending in said axial direction from a radially outer peripheral edge of said intermediate yoke portion and having an inner peripheral surface that forms a cylindrical space between itself and an outer peripheral surface of said inner yoke portion;
at least one permanent magnet secured to an outer peripheral surface of said inner yoke portion at a position away from said intermediate yoke portion in said axial direction, said at least one permanent magnet having been magnetized in a radial direction of said yoke and forming a magnetic gap between itself and the inner peripheral surface of said outer yoke portion;
a cylindrical voice coil inserted into said cylindrical space in said axial direction to extend into said magnetic gap in said axial direction; and
a diaphragm having an annular coil support portion that supports said voice coil at a position outside said annular space in said axial direction, a cylindrical portion raised toward said annular space from a radially inner peripheral edge of said coil support portion, and an inner portion disposed to close a distal end opening of said cylindrical portion and to face a distal end opening of said inner yoke portion.
